(19) United States
(12) Patent Application Publication
(10) Pub. No.: US 2006/0074983 A1
(43) Pub. Date: Apr. 6, 2006

(54) Method of maintaining data confidentiality

(76) Inventor: Paul H. Jones, Mercer Island, WA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/957,144

(22) Filed: Sep. 30, 2004

(51) Int. Cl. G06F 17/00

(52) U.S. Cl. 707/104.1

(57) ABSTRACT

A method of maintaining data confidentiality. The method of one embodiment comprises receiving patient data at a medical system. Whether the patient data includes protected health information is determined. If the patient data includes protected health information; the patient data is stored in a secure location. The patient data is annotated for protection if the patient data includes protected health information. Access to the patient data is prevented.

### FIELD OF THE INVENTION

The present disclosure pertains to the field of data confidentiality. In particular, protected health information is maintained in confidentiality after entry into a medical device.

### DESCRIPTION OF RELATED ART

Identity theft and identity fraud occur when someone uses your personal information without your permission to commit fraud or other crimes. Unlike fingerprints, which are unique to a specific person and cannot be given to someone else for their use, personal data especially a Social Security number, bank account or credit card number, birth date, and other valuable identifying data can be used, if they fall into the wrong hands, to personally profit at another person's expense. In the United States and Canada, for example, many people have reported that unauthorized persons have taken funds out of their bank or financial accounts, or, in the worst cases, taken over their identities altogether, running up vast debts and committing crimes while using the victims' names. In many cases, a victim's losses may include not only out-of-pocket financial losses, but substantial additional financial costs associated with trying to restore his reputation in the community and correcting erroneous information for which the criminal is responsible. Identity theft is a serious crime.

Many people do not realize how easily criminals can obtain personal data without having to break into homes. In public places, for example, criminals may engage in “shoulder surfing”—watching you from a nearby location as you punch in your telephone calling card number or credit card number or listen in on your conversation if you give your Social Security number to the receptionist at a medical facility. Even the area near your home or office may not be secure. Some criminals engage in “dumpster diving”—going through your garbage cans or a communal dumpster or trash bin—to obtain copies of your checks, credit card or bank statements, or other records that typically bear your name, address, and even your telephone number. These types of records make it easier for criminals to get control over accounts in your name and assume your identity. In recent years, the Internet has become an appealing place for criminals to obtain identifying data, such as passwords or even banking information. In some cases, criminals reportedly have used computer technology to obtain large amounts of personal data.

With enough identifying information about an individual, a criminal can take over that individual's identity to conduct a wide range of crimes: for example, false applications for loans and credit cards, fraudulent withdrawals from bank accounts, fraudulent use of telephone calling cards, or obtaining other goods or privileges which the criminal might be denied if he were to use his real name. If the criminal takes steps to ensure that bills for the falsely obtained credit cards, or bank statements showing the unauthorized withdrawals, are sent to an address other than the victim's, the victim may not become aware of what is happing until the criminal has already inflicted substantial damage on the victim's assets, credit, and reputation.

Thus there is a need to enact precautions to protect against the theft of personal information and data.

### BRIEF SUMMARY

A method of maintaining data confidentiality is disclosed. The method of one embodiment comprises receiving patient data at a medical system. Whether the patient data includes protected health information is determined. If the patient data includes protected health information; the patient data is stored in a secure location. The patient data is annotated for protection if the patient data includes protected health information. Access to the patient data is prevented.

Other features and advantages of the present invention will be apparent from the accompanying drawings and from the detailed description that follow below.

### BRIEF DESCRIPTION OF THE FIGURES

The present invention is illustrated by way of example and not limitation in the Figures of the accompanying drawings, in which like references indicate similar elements.

FIG. 1 is a block diagram of a medical diagnostic ultrasound imaging system to maintain patient data confidentiality in accordance with one embodiment of the present invention;

FIGS. 2A-D are illustrations of various medical database screens displaying patient information for use with one embodiment of the present invention;

FIGS. 3A-D are illustrations of the modified medical database screens of FIGS. 2A-D upon employment of one embodiment of the present invention;

FIG. 4 is a flowchart illustrating one embodiment of a method to protect patient heath information upon entry of data into a system; and

FIG. 5 is a flowchart illustrating one embodiment of a method to protect protected health information during normal medical database use.

### DETAILED DESCRIPTION

The following description describes embodiments of a method of maintaining data confidentiality. In the following description, numerous specific details such as ultrasound imaging system components, protected health information types, and the like are set forth in order to provide a more thorough understanding of the present invention. It will be appreciated, however, by one skilled in the art that the invention may be practiced without such specific details. Additionally, some well known structures, algorithms, and the like have not been shown in detail to avoid unnecessarily obscuring the present invention.

Most people feel that their personal health and medical information is private and should be protected. As a result, the United States Congress enacted the Health Insurance Portability and Accountability Act (HIPAA) Privacy Rule in 1996 as the first comprehensive Federal protection for the privacy and security of protected health information (PHI). Patient confidentiality has become even more important after the implementation of HIPAA. Medical institutions are responsible for ensuring that PHI described in HIPAA is not revealed to unauthorized persons. PHI under HIPAA is individually identifiable health information. Identifiable refers not only to data that is explicitly linked to a particular individual, but also includes health information with data items which reasonably could be expected to allow individual identification. As required by Congress in HIPAA, the Privacy Rule not only covers health plans, health care clearinghouse, and health care providers who conduct certain financial and administrative transactions electronically, but also most doctors, nurses, pharmacies, hospitals, clinics, nursing homes, and other health care providers. The type of information protected includes any information a doctor, nurse, and other health care providers put in a medical record, conversations a doctor has about care or treatment with nurses and others, information about the health insurer, and most other health information held about a patient.

HIPAA sets rules and limits on who can look at and receive PHI. For instance, PHI can be used and shared for treatment/care coordination, to pay doctors and hospitals, to protect public health in terms of reporting epidemics, and to report gunshot wounds to the police. However, PHI cannot be used or shared without a patient's written permission unless allowed by law. For example, without a patient's authorization, a medical care provider cannot give patient information to an employer, share information for marketing or advertising purpose, or share private notes about mental health counseling sessions. Thus health care providers and any other medical parties that receive, process, or use PHI need to employ protective measures to safeguard PHI.

Although medical institutions strive to keep PHI confidential, in certain areas this may be difficult. For example, once a patient's PHI is entered onto the screen of an ultrasound system, a patient scheduling screen, or other medical device, unauthorized persons may inadvertently or deliberately see the data. This can be especially true if the screen is left unattended or in a quasi-public area. Unauthorized persons can include other patients, commercial vendors, hospital employees, or others who have a legitimate reason to be in an area where they can see the screen but are not authorized to view a patient's PHI. In a practical sense, it can often be difficult to keep unauthorized persons from intentionally or unintentionally viewing PHI.

Embodiments of the present invention describe a method to keep PHI from being see by unauthorized individuals. Presently, a patient information such as a name, age, address, etc. can be viewed on an ultrasound system or office visit scheduling screen by unauthorized persons when the screen or station is left unattended. In one embodiment of the present invention, a plurality of data field containing PHI hide the information after a predefined or user selectable time out period. In another embodiment, the fields can be hidden after a designated confidentiality function key is depressed. Upon activation of the confidentiality feature at the end of a time out period or by a special keystroke, all PHI data fields are either blanked out or replaced with asterisks “***”. Thus hiding a patient's name, birth date, or insurance number. For one embodiment, the data field to be blanked out and the time out period are user selectable. In another embodiment, a system manufacturer or hospital administrator can set provide a default time out period and/or a default list of PHI fields. The PHI data is made accessible again only after an authorized person enters a valid password or access code. In one embodiment, some of the other functionality of the system can still be operational. For example, even though the PHI on the screen of an ultrasound screen is unreadable, the ultrasound scanning functionality is still operative. Thus a service technician or sonographer can continue to use the ultrasound system without actually viewing or accessing a patient's PHI.

Although the following embodiments are described with reference to an diagnostic ultrasound system, other embodiments are applicable to other types of medical imaging systems and patient information gathering devices. The same techniques and teachings of the present invention can easily be applied to other types of information systems that can benefit from greater security and improved performance. The teachings of the present invention are applicable to any data devices or machine that gather or process confidential information. Moreover, the present invention is not limited to machines in the medical field that handle patient data and can be applied to any type of machine in which manipulation of confidential data is needed. The type and amount of PHI that is involved can vary widely from situation to situation. In some implementations, the PHI that is protected includes, but is no way limited to: patient names; addresses; voice and fax numbers; e-mail addresses; medical record numbers; health plan account numbers; certificate/license numbers; birth, admission, and discharge dates; Social Security number; vehicle identifiers; IP addresses; biometric identifiers including finger and voice prints; full face photographic images and any comparable images; and any other unique identifying number, characteristic, or code.

In the following description, for purposes of explanation, numerous specific details are set forth in order to provide a thorough understanding of the present invention. One of ordinary skill in the art, however, will appreciate that these specific details are not necessary in order to practice the present invention. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention.

Although the below examples describe the handling and distribution of protected health information in the context of diagnostic medical ultrasound systems, other embodiments of the present invention can be accomplished by way of software. In one embodiment, the methods of the present invention are embodied in machine-executable instructions. The instructions can be used to cause a general-purpose or special-purpose processor that is programmed with the instructions to perform the steps of the present invention. The present invention may be provided as a computer program product or software which may include a machine or computer-readable medium having stored thereon instructions which may be used to program a computer (or other electronic devices) to perform a process according to the present invention. Alternatively, the steps of the present invention might be performed by specific hardware components that contain hardwired logic for performing the steps, or by any combination of programmed computer components and custom hardware components. Such software can be stored within a memory in the system. Similarly, the code can be distributed via a network or by way of other computer readable media.

Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like. Accordingly, the computer-readable medium includes any type of media/machine-readable medium suitable for storing or transmitting electronic instructions or information in a form readable by a machine (e.g., a computer). Moreover, the present invention may also be downloaded as a computer program product. As such, the program may be transferred from a remote computer (e.g., a server) to a requesting computer (e.g., a client). The transfer of the program may be by way of electrical, optical, acoustical, or other forms of data signals embodied in a carrier wave or other propagation medium via a communication link (e.g., a modem, network connection or the like).

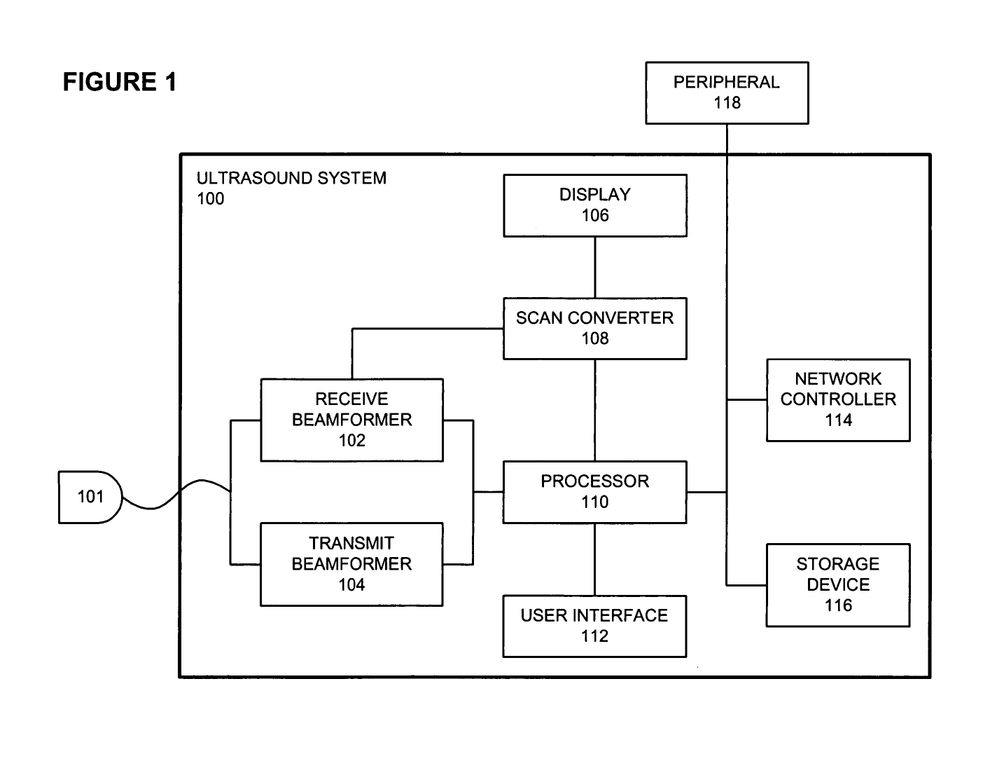

FIG. 1 is a block diagram of a medical diagnostic ultrasound imaging system 100 to maintain patient data confidentiality in accordance with one embodiment of the present invention. It will be appreciated that the disclosed embodiments are also applicable to other medical diagnostic imaging systems such as computed radiography, magnetic resonance, angioscopy, color flow Doppler, cystoscopy, diaphanography, echocardiography, fluoresosin angiography, laparoscopy, magnetic resonance angiography, positron emission tomography, single-photon emission computed tomography, x-ray angiography, computed tomography, nuclear medicine, biomagnetic imaging, culposcopy, duplex Doppler, digital microscopy, endoscopy, fundoscopy, laser surface scan, magnetic resonance spectroscopy, radiographic imaging, thermography, radio fluroscopy, or any combination thereof. Further, it will be appreciated that the disclosed embodiments are also applicable to therapeutic ultrasound systems. The disclosed embodiments are also applicable to other medical devices such as bedside patient monitors and central patient monitoring stations which are typically found in critical care units, neonatal units and emergency departments.

As shown in FIG. 1, ultrasound system 100 comprises a transducer 101 coupled with a transmitter, such as a transmit beamformer 104 and a receiver, such as a receive beamformer 102. Alternatively, as described below, other types of transmitters and/or receivers may be used. Herein, the phrase “coupled with” is defined to mean directly connected to or indirectly connected through one or more intermediate components. Such intermediate components may include both hardware and software based components. The beamformers 102, 104, are each coupled with a processor 110, which is coupled with a scan converter 108, user interface 112, network controller 114, storage device 116, and a peripheral 118. The processor 110 can also include a memory device that stores software executable by the processor 110. The term “processor” broadly refers to hardware and/or software components of the ultrasound system 100 that can be used to implement the preferred embodiments described herein. It should be understood that any appropriate hardware (analog or digital) or software can be used and that the embodiments described herein can be implemented exclusively with hardware. Further, the processor 110 can be separate from or combined with (in whole or in part) other processors of the ultrasound system 100 (including attendant processors), which are not shown in FIG. 1 for simplicity. It should also be noted that the ultrasound imaging system 100 can comprise additional components. Further, the ultrasound system 100 can be used with any suitable imaging mode (e.g., B-mode imaging, Doppler imaging, tissue harmonic imaging, contrast agent harmonic imaging, etc.), and the transducer 101 can be of any type (e.g., 1D, 1.5D, 2D, plano-concave, single element, phased-array, etc.).

In operation, the processor 110 responds to information and commands entered through the user interface 112 and controls the operation of the ultrasound system 100. User interface can include a keyboard, trackball, pointer device, sliding controls, etc. In one embodiment, the user interface also includes hardware to receive and process biometric data. The processor 110 causes the transmit beamformer 104 to apply a voltage to the transducer 101. The transducer 101 vibrates and emits an ultrasonic beam into an object, such as human tissue (i.e., a patient's body). Ultrasonic energy reflected from the body impinges on the transducer 101, and the resulting voltages created by the transducer 101 are received by the receive beamformer 102. The scan converter 108, under control of the processor 110, processes the sensed voltages to create an ultrasound image associated with the reflected signals and displays the image on a display 106. The user interface 112 can be used, for example, to adjust parameters used in the transmit, receive, and display operations. It should be noted that the ultrasound imaging system 100 can comprise additional components. The processor 110 can also store the generated image and other ultrasound examination data in the storage device 116 (e.g., a hard drive). As used herein, the term “ultrasound examination data” is meant to broadly refer to ultrasound image data (still images and/or dynamic clips) and/or non-image data (such as calculation data and patient data) associated with an ultrasound examination. Thus ultrasound data can include, but is not limited to, ultrasound examination data, images, audio data, calculations, reports, screen captures of measurements or report data, indications of diagnosis, raw system data (such as prescan-converted acoustic data, physio waveforms, operating parameters, and front-end complex data of coherent beam forming systems), information about the ultrasound system, information about an ultrasound peripheral, and software applications that can be installed by the ultrasound system's processor.

It will be appreciated that alternative methods of generating and controlling ultrasonic energy as well as receiving and interpreting echoes received therefrom for the purpose of diagnostic imaging, now or later developed, may also be used with the disclosed embodiments in addition to or in substitution of current beamforming technologies. Such technologies include technologies which use transmitters and/or receivers which eliminate the need to transmit ultrasonic energy into the subject along focused beam lines, thereby eliminating the need for a transmit beamformer, and may permit beam forming to be performed by post processing the received echoes. Such post-processing may be performed by a receive beamformer or by digital or analog signal processing techniques performed on the received echo data.

Also for simplicity, the term “ultrasound peripheral” is used here to broadly refer to any device that can receive ultrasound data from the ultrasound system 100 and/or that can transmit ultrasound data to the ultrasound system 100. The widest variety of devices can be used as ultrasound peripherals, such as, but not limited to, video imagers, digital workstations, analog or digital mass storage devices, analog or digital video recording devices, printers, as well as other ultrasound imaging systems. In some situations, a device, such as a printer, can be used in the network to receive both ultrasound data (hence, acting as an ultrasound peripheral) and non-ultrasound data from other devices or applications.

To transmit ultrasound data to an on-cart peripheral 118 connected to the ultrasound system 100 with a wired connection, the processor provides the ultrasound data directly to the on-cart peripheral 118, such as a VCR. To transmit ultrasound data to an ultrasound peripheral that is not wired to the ultrasound system 100, the processor 110 provides a network controller 114 with an instruction to transmit ultrasound data as well as with the location of the ultrasound data to be transmitted. The network controller 114 retrieves the ultrasound data from the location and then packages and addresses the data according to a network protocol such as IEEE 802, TCP/IP, or UDP, for example. The network controller 114 then delivers the ultrasound data to a wireless communication device for wireless transmission to an ultrasound peripheral.

For one embodiment of the present invention, protection algorithms are implemented through software. In alternative embodiments, these algorithms can be implemented through hardware, firmware, or a combination thereof. In one embodiment, the algorithms allow fields containing patient information to be blanked out on a display screen after the information is entered. The fields that are blanked out can be chosen in a preset menu. Typically, the preselected fields can include a patient's name, birth data, hospital number, address, phone number or other PHI. The algorithms in some embodiments can allow for a certain time out period to be defined for these data fields. For example, the data in a field may disappear from a display screen or revert to asterisks at one, two, or five minutes, or any other period of time after the last input of data onto the screen. For other implementations of the algorithms, users are allowed to blank out the data fields on a display screen when desired. For example, this could be done by pressing a designated function key or a special combination/sequence of keys when leaving an exam room or other location where the PHI is displayed.

Some embodiments of these algorithms to protect PHI allow authorized users to redisplay the PHI on the blanked out screen when a password or code is entered. Redisplay of the PHI can also be allowed following the entry of biometric data (retina scan, fingerprint, etc.) of an authorized person if biometric data entry is supported. In order to track patient data and monitor database security, some embodiments of the present invention also log all the attempts to retrieve PHI and track which users have accessed the PHI and at what time. This can help provide a record of what happens with the PHI. Although the embodiments as described in the present examples are in the context of diagnostic medical ultrasound systems and medical data systems, other embodiments of the present invention are also applicable in non-medical related fields as well where maintaining the privacy and confidentiality of client data is critical. For example, alternative embodiments of the present invention can be utilized in banks, governmental agencies, educational institutions, and other environments where it is either mandated or desirable to protect the privacy of names, addresses, Social Security numbers, account numbers, etc. Private personal information can include any type of information that a person such as a client may not want to have shared or disclosed such as names, addresses, Social Security numbers, financial account numbers, license numbers, grades, birth dates, etc. Similarly, the present enhancements are not limited to medical systems or computer workstations. Alternative embodiments of the present invention can be used in other devices such as handheld devices and embedded applications. Some examples of handheld devices include cellular phones, Internet Protocol devices, digital cameras, personal digital assistants (PDAs), and handheld PCs.

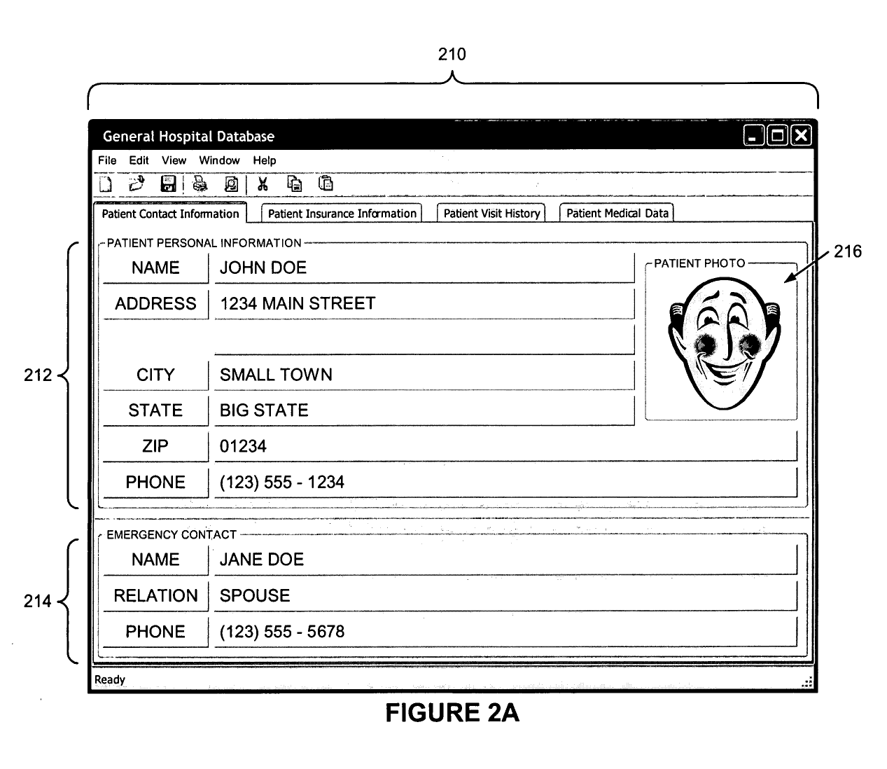

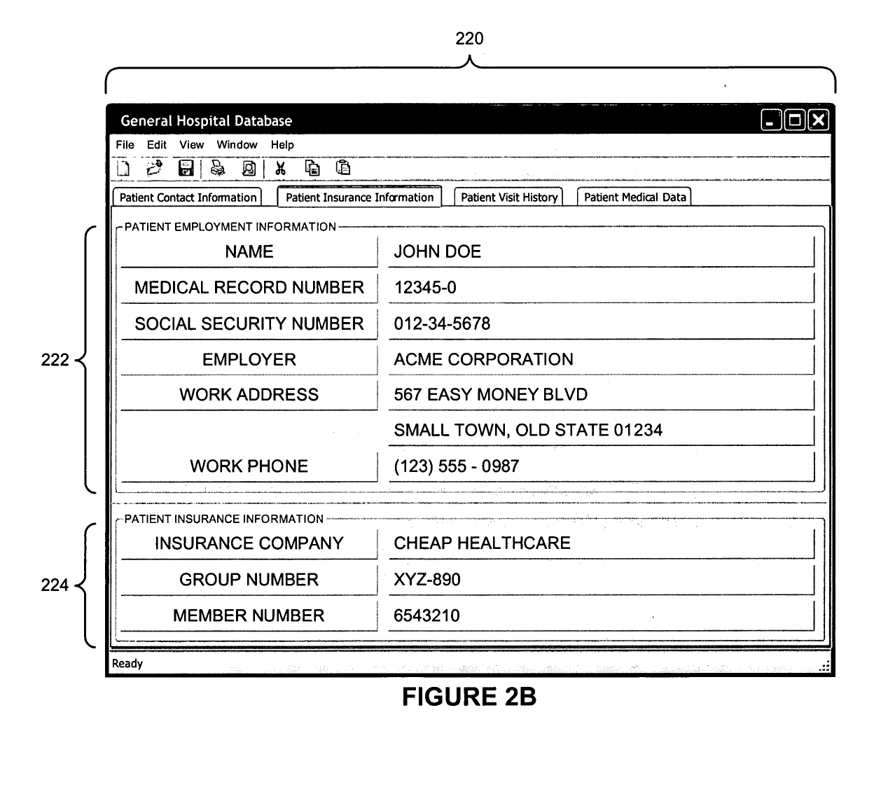

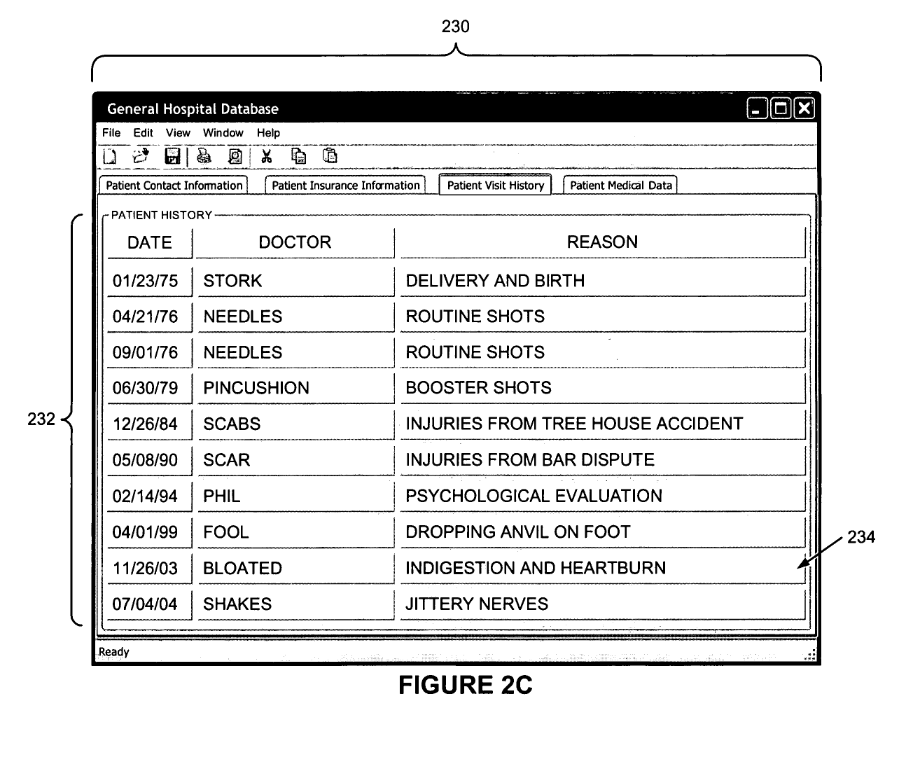

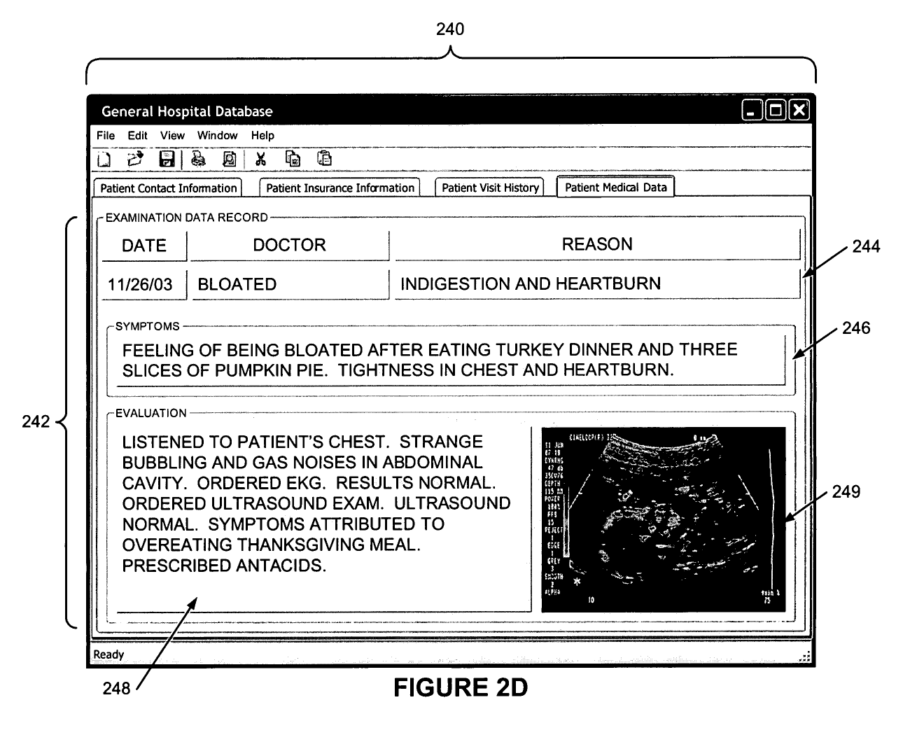

FIGS. 2A-D are illustrations of various medical database screens displaying patient information for use with one embodiment of the present invention. These exemplary screen shots include different windows to display some of the types of confidential patient health information desired to be protected. FIG. 2A illustrates a first database screen 210 having the ‘Patient Contact Information’ tab selected. On this first screen 210, the type of patient information available can include personal information 212 such as name, address, phone number, and photo 216. This first screen 210 can also include emergency contact information 214. Similarly, FIG. 2B illustrates a second database screen 220 having the ‘Patient Insurance Information’ tab selected. On this second screen 220, additional personal patient information such as employment information 222 and medical insurance information 224 can be accessible. Although some of the information like an employer name or work phone number may not appear to be highly confidential, other items such as a Social Security number are birth date are. However, whether or not the type of information accessible is critical in nature, patients and clients may desire to have their privacy respected and their personal information protected from either inadvertent disclosure or intentional misuse.

FIG. 2C illustrates a third database window 230. This third window 230 has the ‘Patient Visit History’ tab selected and provides a historical listing 232 of patient visits. In this example, the listing includes not only the date and reason for the visit, but also the attending doctor. FIG. 2D illustrates a fourth database window 240 in which ‘Patient Medical Data’ is available for each of the visits listed on the ‘Patient Visit History’ tab. In this example, the patient visit 234 of Nov. 26, 2003 for indigestion and heartburn is selected for more information. The examination data record 242 of FIG. 2D provides the user with a detailed medical record of a particular visit. This data record 242 can include a note 244, 246, regarding the symptoms involved, the medical evaluation 248 provided, and any test results such as an ultrasound image 249.

Because of the need to protect against the unauthorized and/or inadvertent access and/or distribution of any confidential patient medical information, protective measures such the methods described in various embodiments of the present invention need to be employed. In one embodiment of the present invention, certain confidential aspects of a patient's medical record are predefined as requiring special treatment. For example, some elements such as a patient's contact information, birth date, Social Security number, and financial data are particularly sensitive. The medical provider owes its patients a certain duty of care in keeping safe this information and allowing only authorized access to it. Thus when a new patient record is created in a medical database, certain aspects of the protected health information is noted as protected data and stored in a secure format. This information is not retrieved during routine database access. For example, a random user on a hospital workstation would not be able to easily obtain patient data from the hospital database. In one embodiment, the medical provider can designate portions of a patient's medical record as not viewable or inaccessible unless a valid access code is provided. Similarly, in another embodiment, the patient database can be equipped with a data locking or blanking feature in which a user can hide or wipe all of the fields containing confidential protected health information from the visible screen. This may be useful in instances where the authorized user needs to leave the medical workstation or system unattended, but does not want any confidential patient information comprised.

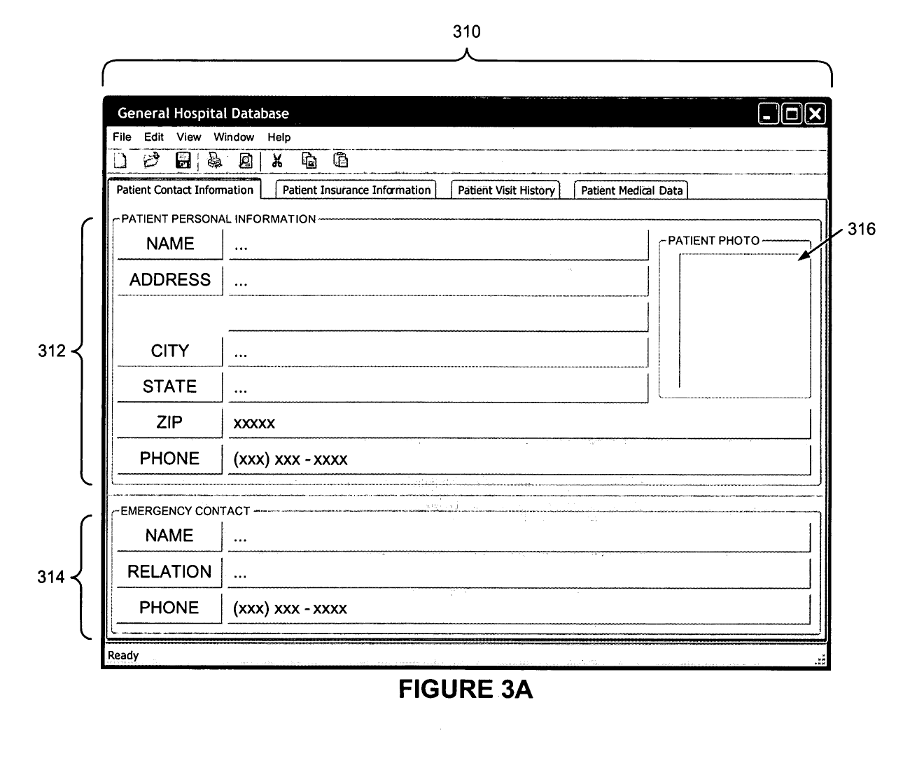

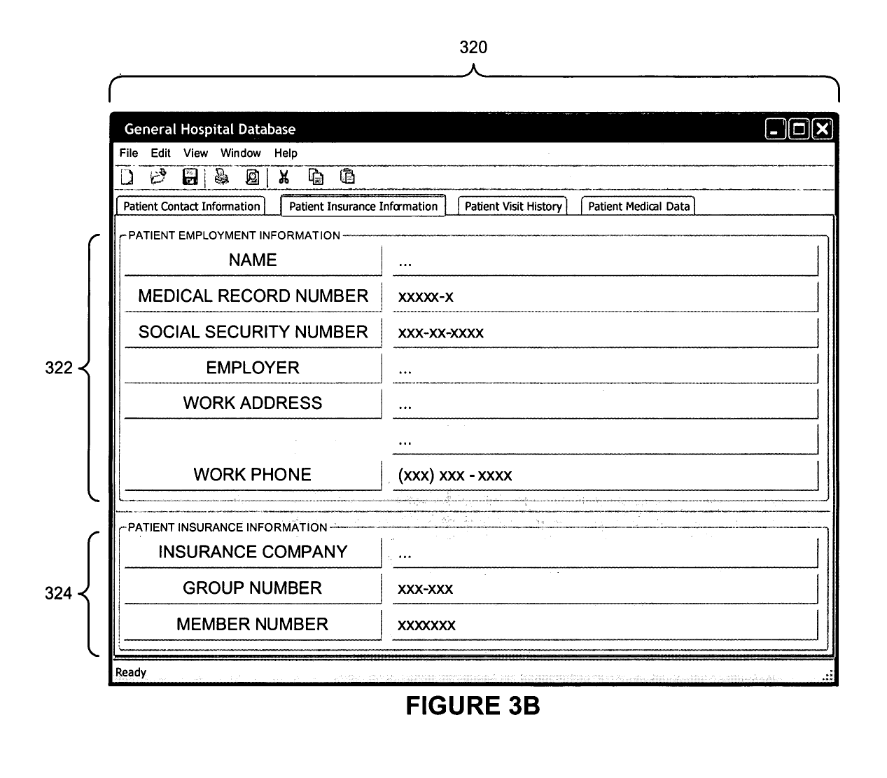

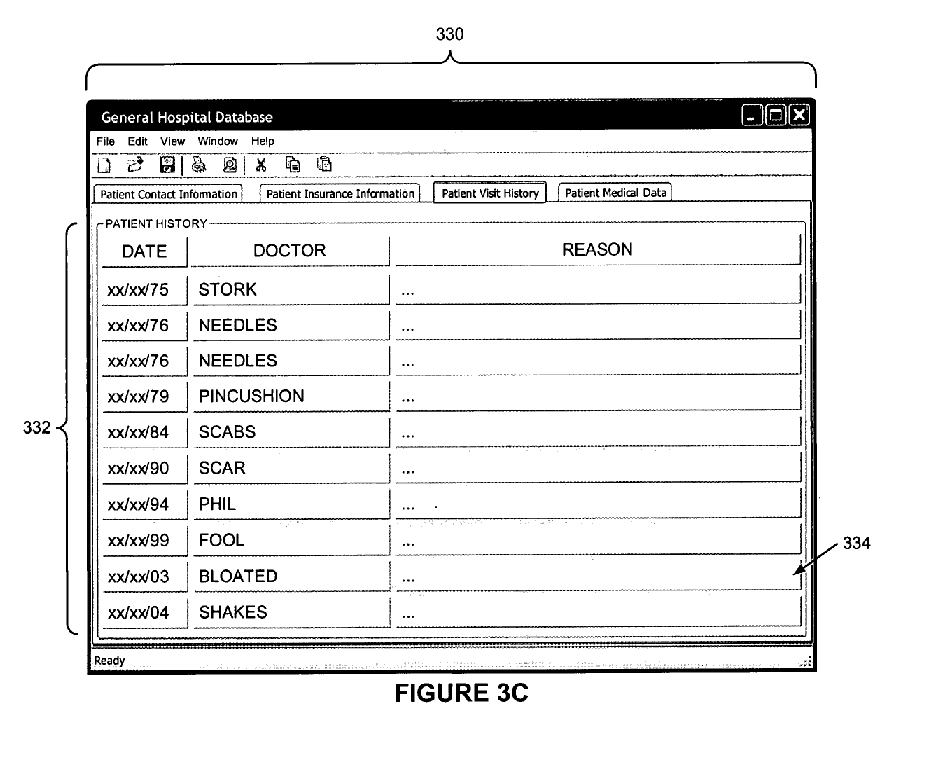

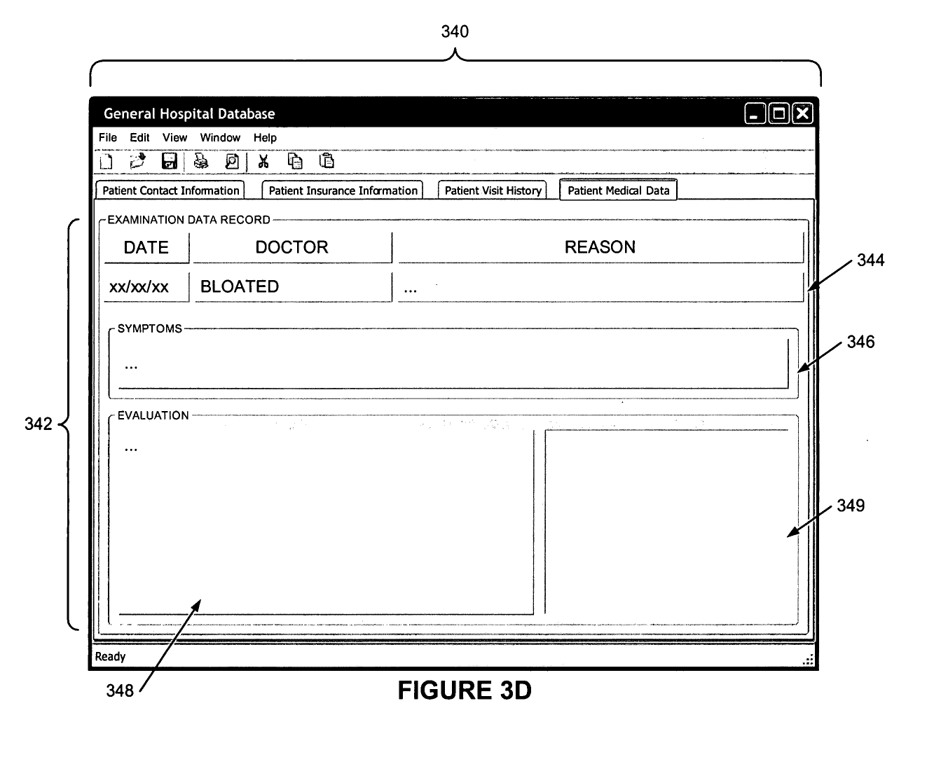

FIGS. 3A-D are illustrations of the modified medical database screens of FIGS. 2A-D upon employment of one embodiment of the present invention. In this example, various fields of the patient database have been marked as confidential personal health information. Upon the activation of a protection mechanism in accordance with one embodiment of the present invention, these fields of the patient database are protected. In one embodiment, the entries in these fields are replaced with asterisks ‘*’, dots ‘ . . . ’ or X's. For another embodiment, the entries are replaced with random symbols or gibberish. In yet another embodiment, the entries are wiped or blanked out and replaced with empty spaces. Thus the confidential protected health information is rendered inaccessible. For this embodiment, if an unauthorized user attempts to use the workstation to access another patient's data, that patient's record would also be protected and return from the database as unreadable either as asterisks or empty fields.

FIG. 3A illustrates a modified first database screen 310 having the ‘Patient Contact Information’ tab selected. On this version of the first screen 210 from FIG. 2A, the patient contact information is made unavailable. For example, the personal information 212 such as name, address, phone number, and photo 216 are no longer viewable and have been replaced with dots, X's, or blanked out. The emergency contact information 314 is also hidden on this modified first screen 310. Similarly, FIG. 3B illustrates a second protected database screen 320 having the ‘Patient Insurance Information’ tab selected. On this second modified screen 320, the additional personal patient information such as employment information 322 and medical insurance information 324 from FIG. 2B are no not accessible. FIG. 3C illustrates a third protected database window 330. This third window 330 has the ‘Patient Visit History’ tab selected and provides a partial historical listing 332 of patient visits. In this example, the listing only provides the year for various visits and the attending physician name. The full date and reason for the visit have been designated as confidential protected health information and are blocked from viewing. FIG. 3D illustrates a fourth protected database window 340 in which ‘Patient Medical Data’ was previously available in FIG. 3D for each of the visits listed on the ‘Patient Visit History’ tab. In this instance, the patient visit 334 with Dr. Bloated in 2003 is selected for more information. However, the examination data record 342 of FIG. 3D provides the user with no details about that visit. For this embodiment, the data record 342 all the entries including any notes 344, 346, medical evaluation 348, and test results 349 are made unviewable.

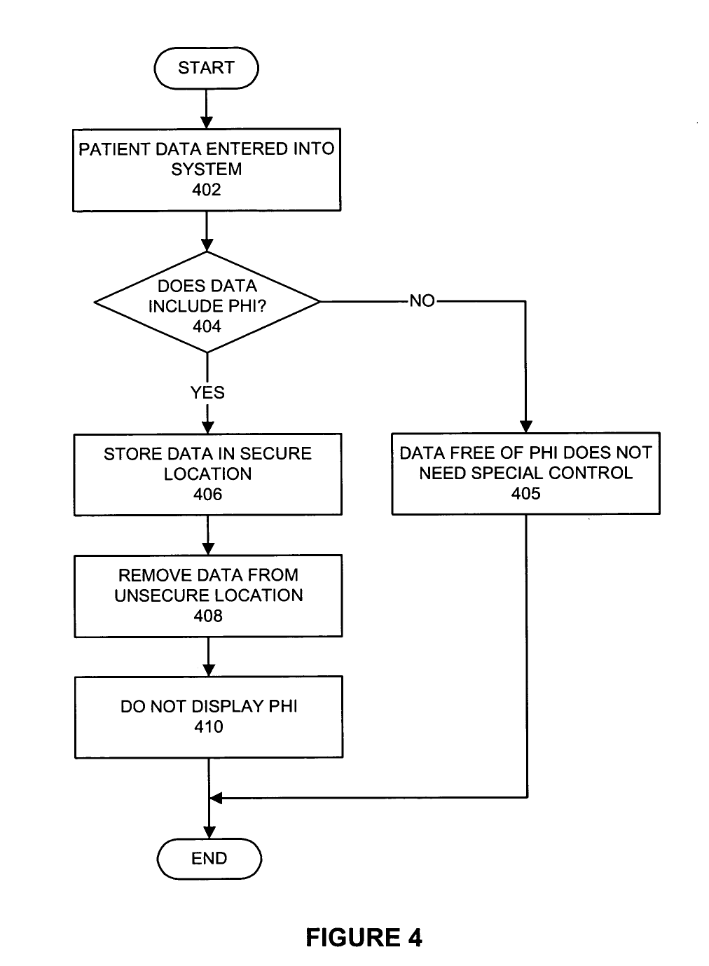

FIG. 4 is a flowchart illustrating one embodiment of a method to protect patient heath information upon entry of data into a system. At block 402, patient data is entered into a system. For example, a system can be a diagnostic ultrasound machine, medical workstation, computer, or any personal health information data entry point. A check is performed at block 404 to determine whether the patient data includes any protected health information. If the data does not contain any protected health information, then that data does not need special control or protection and is processed at block 405. But if the data is determined to contain protected health information at block 404, then the data is stored in a secure location at block 406. At block 408, any of the data containing protected health information stored at an unsecured location is removed. Any protected health information is also removed from the display at block 410.

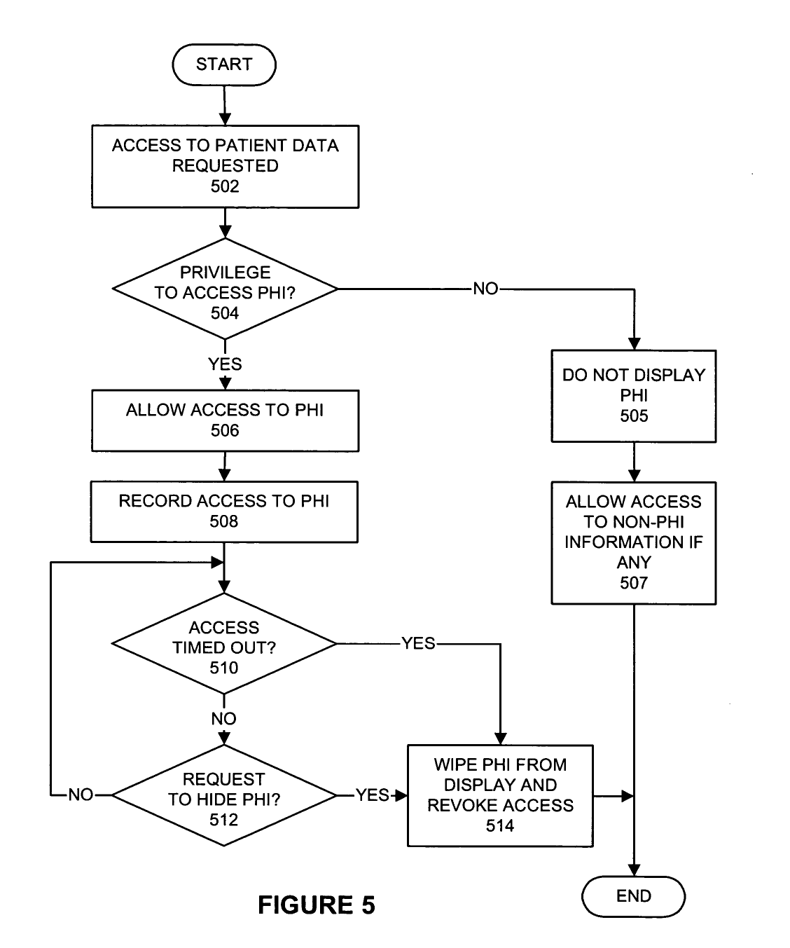

FIG. 5 is a flowchart illustrating one embodiment of a method to protect protected health information during normal medical database use. At block 502, access to patient data is requested. A check is made at block 504 to determine whether the user has the proper privilege to access protected health information. If the result of the determination is negative, then protected health information is not displayed at block 505. Access to non-protected health information if any may be allowed at block 507. If the determination at block 504 indicates that the user has the proper access privilege, access is granted to the patient's protected health information at block 506. At block 508, this access to protected health information is recorded and logged.

At block 510, a check is conducted to determine whether this access to protected health information has timed out yet. For example, in one embodiment, an access is considered timed out if there has been no activity at the system or display for a predetermined period of time such as five minutes. If the access has timed out, then at block 514, all protected health information is wiped from the display and access is revoked. If the access has not times out at block 510, a similar check is performed at block 512 to determine whether a user request to hide the protected health information has been received. If a request to blank all protected health information has been received at block 512, then all protected health information is wiped from the display at block 514 and access is revoked. If a request to blank has not been received, the system continues to monitor the inactivity time at block 510 and poll for hide requests at block 512.

Thus, techniques for a method of maintaining data confidentiality are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A method comprising:
receiving patient data at a medical system;
determining whether said patient data includes protected health information;
storing said patient data in a secure location if said patient data includes protected health information;
annotating said patient data for protection if said patient data includes protected health information; and
preventing access to said patient data.

2. The method of claim 1 wherein said medical system is a diagnostic imaging ultrasound system.

3. The method of claim 1 wherein said medical system is a computer.

4. The method of claim 1 wherein said preventing access to said patient data occurs after a time out period.

5. The method of claim 4 wherein said time out period is defined as a set period of inactivity at said medical system.

6. The method of claim 1 wherein said preventing access to said patient data occurs after receiving a keystroke from a user.

7. The method of claim 1 wherein said preventing access to said patient data further comprises blanking out said protected health information from a screen.

8. The method of claim 1 wherein said preventing access to said patient data further comprises covering said protected health information with asterisks on a screen.

9. The method of claim 1 wherein said access to said patient data is granted after receiving a password.

10. The method of claim 1 wherein said access to said patient data is granted after receiving a biometric signature.

11. A method comprising:
receiving a request to access patient data including protected health information;
determining whether requestor has privilege to access said protected health information;
wherein if said requestor does have said privilege to access said protected health information, then:
granting access to said protected health information.

12. The method of claim 11 wherein said granting access further comprises:
displaying said protected health information; and
recording said access to said protected health information.

13. The method of claim 11 further comprising:
wherein if said requester does not have said privilege to access said protected health information, then:
denying access to said protected health information.

14. The method of claim 13 wherein said denying access further comprises not displaying said protected health information.

15. The method of claim 14 further comprising displaying patient data that is not protected health information.

16. The method of claim 11 further comprising:
determining whether said access to said protected health information has timed out; and
if said access has timed out, then revoking said access to said protected health information and hiding said protected health information from viewable display.

17. The method of claim 11 further comprising:
determining whether a request to hide said protected health information has been received; and
if said request to hide has been received, then revoking said access to said protected health information and hiding said protected health information from viewable display.

18. The method of claim 11 wherein said request to access said patient data is received on an ultrasound system.

19. An article comprising a machine readable medium that stores a program, said program being executable by a machine to perform a method comprising:
receiving a request to access patient data including protected health information;
determining whether requestor has privilege to access said protected health information;
wherein if said requestor does have said privilege to access said protected health information, then:
granting access to said protected health information.

20. The method of claim 19 wherein said granting access further comprises:
displaying said protected health information; and
recording said access to said protected health information.

21. The method of claim 19 further comprising:
wherein if said requestor does not have said privilege to access said protected health information, then:
denying access to said protected health information.

22. The method of claim 19 further comprising:
determining whether said access to said protected health information has timed out; and
if said access has timed out, then revoking said access to said protected health information and hiding said protected health information from viewable display.

23. The method of claim 19 further comprising:
determining whether a request to hide said protected health information has been received; and
if said request to hide has been received, then revoking said access to said protected health information and hiding said protected health information from viewable display.

24. The article of claim 19 wherein said machine perform said method upon executing of said program stored on said machine readable medium is an ultrasound imaging system.

25. A system comprising:
a memory to store data and instructions;
a processor coupled to said memory on a bus, said processor operable to perform instructions for an algorithm to maintain data confidentiality, said processor comprising:
a bus unit to receive a sequence of instructions from said memory;
an execution unit coupled to said bus unit, said execution unit to execute said sequence, said sequence to cause said system to:
receive patient data;
determine whether said patient data includes protected health information;
store said patient data in a secure memory location if said patient data includes protected health information;
annotate said patient data for protection if said patient data includes protected health information; and
prevent access to said patient data.

26. The system of claim 25 wherein said system is a diagnostic ultrasound system.

27. The system of claim 25 wherein said system is a medical workstation.

28. The system of claim 25 wherein said preventing access to said patient data further comprises blanking out said protected health information from a screen.

29. The system of claim 25 wherein said preventing access to said patient data further comprises covering said protected health information with asterisks on a screen.

30. The system of claim 25 wherein said access to said patient data is granted after receiving a password.

31. A system comprising:
a memory to store data and instructions;
a processor coupled to said memory on a bus, said processor operable to perform instructions for an algorithm to maintain data confidentiality, said processor comprising:
a bus unit to receive a sequence of instructions from said memory;
an execution unit coupled to said bus unit, said execution unit to execute said sequence, said sequence to cause said system to:
receive a request to access patient data including protected health information;
determine whether requestor has privilege to access said protected health information;
wherein if said requestor does have said privilege to access said protected health information, then:
grant access to said protected health information.

32. The system of claim 31 wherein said system is a diagnostic ultrasound system.

33. The system of claim 31 wherein said granting access further comprises:
displaying said protected health information; and
recording said access to said protected health information.

34. The system of claim 31 wherein said sequence further causes said system to:
wherein if said requestor does not have said privilege to access said protected health information, then:
deny access to said protected health information.

35. The system of claim 31 wherein said sequence further causes said system to:
determine whether said access to said protected health information has timed out; and
if said access has timed out, then revoking said access to said protected health information and hiding said protected health information from viewable display.

36. The system of claim 31 wherein said sequence further causes said system to:
determine whether a request to hide said protected health information has been received; and
if said request to hide has been received, then revoking said access to said protected health information and hiding said protected health information from viewable display.

37. A method comprising:
receiving client data at a computer system;
determining whether said client data includes private personal information;
storing said client data in a secure location if said client data includes private personal information;
annotating said client data for protection if said client data includes private personal information; and
preventing access to said client data.

38. The method of claim 37 wherein said preventing access to said client data occurs after a time out period.

39. The method of claim 38 wherein said time out period is defined as a set period of inactivity at said computer system.

40. The method of claim 37 wherein said preventing access to said client data occurs after receiving a keystroke from a user.

41. The method of claim 37 wherein said preventing access to said client data further comprises blanking out said private personal information from a screen.

42. The method of claim 37 wherein said preventing access to said client data further comprises covering said private personal information with asterisks on a screen.

43. The method of claim 37 wherein said access to said client data is granted after receiving a password.

44. The method of claim 37 wherein said client data is received from a client at a financial institution.

45. The method of claim 37 wherein said client data is received from a client at a governmental agency.

46. The method of claim 37 wherein said client data is received from a client at an educational institution.

47. A method comprising:
receiving a request to access client data including private personal information;
determining whether requestor has privilege to access said private personal information;
wherein if said requestor does have said privilege to access said private personal information, then:
granting access to said private personal information.

48. The method of claim 47 wherein said granting access further comprises:
displaying said private personal information; and
recording said access to said private personal information.

49. The method of claim 47 further comprising:
wherein if said requestor does not have said privilege to access said private personal information, then:
denying access to said private personal information.

50. The method of claim 47 further comprising:
determining whether said access to said private personal information has timed out; and
if said access has timed out, then revoking said access to said private personal information and hiding said private personal information from viewable display.

51. The method of claim 47 further comprising:
determining whether a request to hide said private personal information has been received; and
if said request to hide has been received, then revoking said access to said private personal information and hiding said private personal information from viewable display.

52. The method of claim 47 wherein said request to access said client data is received on a system of a financial institution.

53. The method of claim 47 wherein said request to access said client data is received on a system of a government agency.

54. The method of claim 47 wherein said request to access said client data is received on a system of an educational institution.
